(19) United States
(12) Patent Application Publication
(10) Pub. No.: US 2011/0031673 A1
(43) Pub. Date: Feb. 10, 2011

(54) SHEET FINISHING APPARATUS AND SHEET FINISHING METHOD

(75) Inventor: Yoshiaki SUGIZAKI, Shizuoka-Ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/839,284

(22) Filed: Jul. 19, 2010

Related U.S. Application Data
(60) Provisional application No. 61/231,191, filed on Aug. 4, 2009.
(60) Provisional application No. 61/318,247, filed on Mar. 26, 2010.

(51) Int. Cl. B41F 13/56; B65H 5/06

(52) U.S. Cl. 270/32; 271/264; 271/275; 270/58.07

(57) ABSTRACT

A sheet finishing apparatus according to an embodiment includes a main body to fold a sheet bundle and to form a booklet, a base plate which is inclined downward and extends from a side wall of the main body and stacks plural booklets successively discharged from an outlet provided in the side wall, an upper arm which is provided above the base plate and substantially in parallel to a stacking surface of the base plate and a base end of which is rotatably supported at an upper part of the outlet of the side wall, a fore arm which extends from a front end of the upper arm to the stacking surface to be substantially perpendicular to the base plate and receives a leading edge of the booklet stacked on the base plate, and an alignment roller which is provided at the front end of the upper arm, presses an upper surface of the booklet stacked on the base plate and rotates in a direction of urging the booklet to the fore arm.

### CROSS-REFERENCE TO RELATED APPLICATIONS

This application is based upon and claims the benefit of priority from: U.S. provisional applications 61/231191 filed on Aug. 4, 2009, and 61/318247 filed on Mar. 26, 2010, the entire contents of each of which are incorporated herein by reference.

### FIELD

Embodiments described herein relate generally to a sheet finishing apparatus and a sheet finishing method.

### BACKGROUND

Hitherto, a sheet finishing apparatus is known which is disposed downstream of an image forming apparatus, such as a copying machine, a printer or an MFP (Multi-Functional Peripheral), performs finishing, such as folding or stitching, on a printed sheet and forms a booklet.

This kind of sheet finishing apparatus is usually provided with a sheet placement section (stacking tray) for stacking plural formed booklets.

The booklets themselves are formed in the finishing apparatus main body, and the booklets successively discharged from an outlet of the finishing apparatus main body are successively stacked on the sheet placement section.

Although the sheet placement section is provided with a mechanism to stably stack many booklets without collapsing of a pile, an improvement of the mechanism is demanded so that more booklets can be more stably stacked.

### BRIEF DESCRIPTION OF THE DRAWINGS

In the accompanying drawings,

FIG. 1 is a perspective view showing an example of an outer appearance of an image forming apparatus including a sheet finishing apparatus of an embodiment;

FIG. 2 is a sectional view showing a structural example of the image forming apparatus;

FIG. 3 is a sectional view showing a structural example of a sheet folding apparatus;

FIG. 4 is a perspective outer appearance view showing a structural example of a sheet placement section;

FIG. 5 is a perspective schematic view in which an upper arm and a fore arm are removed from the sheet placement section;

FIG. 6 is a view in which a sheet placement section of a first embodiment is seen in the front direction of an image forming apparatus;

FIG. 7 is a view schematically showing a drive transmission mechanism of an alignment roller in the sheet placement section of the first embodiment;

FIG. 8 is a view for explaining the operation and effect of the alignment roller in the sheet placement section of the first embodiment;

FIG. 9 is a view in which a sheet placement section of a second embodiment is seen in the front direction of an image forming apparatus; and

FIG. 10 is a view for explaining the operation and effect of an alignment roller and a conveyance assist roller in the sheet placement section of the second embodiment.

### DETAILED DESCRIPTION

Embodiments of a sheet finishing apparatus and a sheet finishing method will be described with reference to the accompanying drawings.

A sheet finishing apparatus according to an embodiment includes a main body to fold a sheet bundle and to form a booklet, a base plate which is inclined downward and extends from a side wall of the main body and stacks plural booklets successively discharged from an outlet provided in the side wall, an upper arm which is provided above the base plate and substantially in parallel to a stacking surface of the base plate and a base end of which is rotatably supported at an upper part of the outlet of the side wall, a fore arm which extends from a front end of the upper arm to the stacking surface to be substantially perpendicular to the base plate and receives a leading edge of the booklet stacked on the base plate, and an alignment roller which is provided at the front end of the upper arm, presses an upper surface of the booklet stacked on the base plate and rotates in a direction of urging the booklet to the fore arm.

### (1) First Embodiment

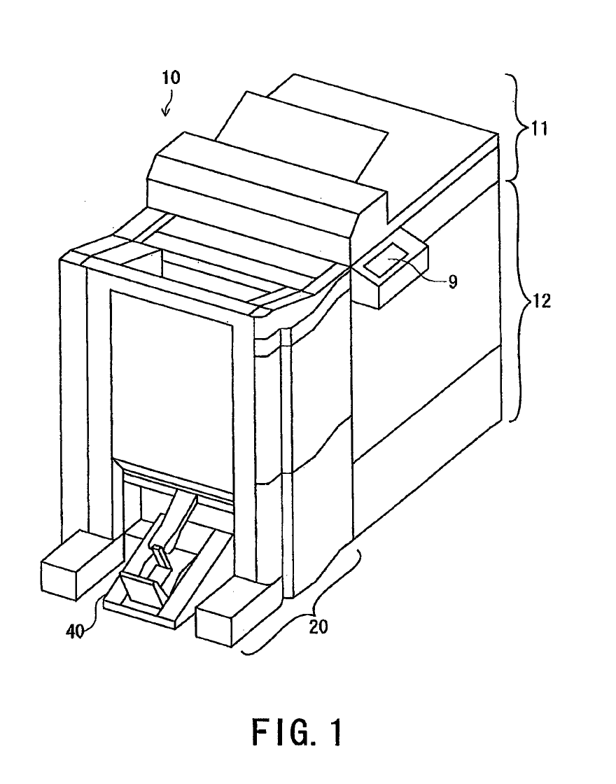

FIG. 1 is an outer appearance perspective view showing a basic structural example of an image forming apparatus 10 including a sheet finishing apparatus 20 of a first embodiment. The image forming apparatus 10 includes a reading section 11 to read a document, an image forming section 12 to print the read image data of the document to a sheet in an electrophotographic system, and the sheet finishing apparatus 20 to perform finishing, such as sorting, punching, folding or saddle stitching, on the printed sheet. The image forming section 12 includes an operation section 9 for a user to perform various operations.

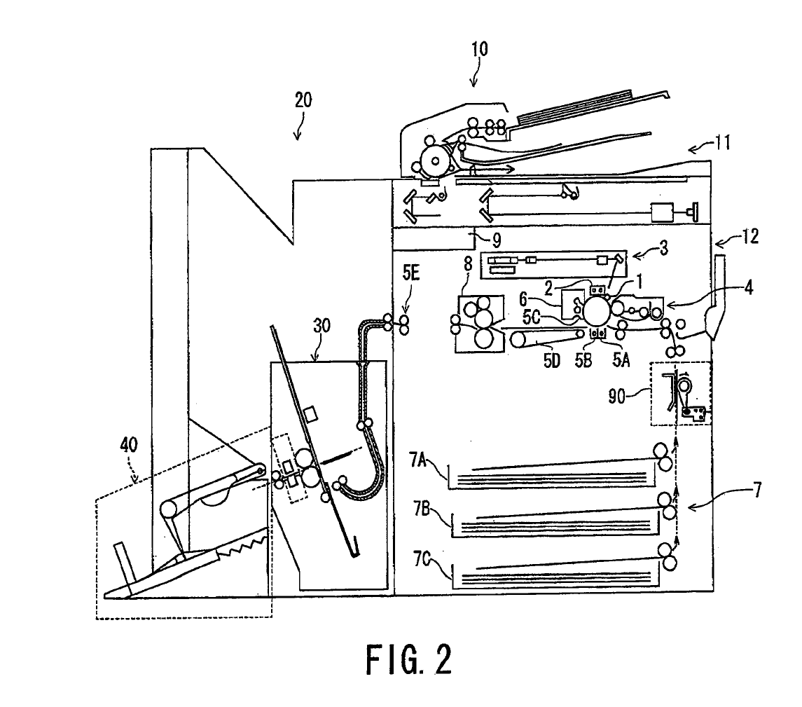

FIG. 2 is a sectional view showing a detailed structural example of the image forming apparatus 10.

The image forming section 12 of the image forming apparatus 10 includes a photoconductive drum 1 at the center. A charging unit 2, an exposure unit 3, a developing unit 4, a transfer unit 5A, a charge removing unit 5B, a separating pawl 5C, and a cleaning unit 6 are respectively disposed around the photoconductive drum 1. Besides, a fixing unit 8 is provided downstream of the charge removing unit 5B. An image forming process is performed by these units substantially in the following procedure.

First, the charging unit 2 uniformly charges the surface of the photoconductive drum 1. On the other hand, a document read by the reading unit 11 is converted into image data, and is inputted to the exposure unit 3. The exposure unit 3 irradiates a laser beam corresponding to the level of the image data to the photoconductive drum 1, and forms an electrostatic latent image on the photoconductive drum 1. The electrostatic latent image is developed with toner supplied from the developing unit 4 and a toner image is formed on the photoconductive drum 1.

A sheet contained in a sheet containing section 7 (7A, 7B, 7C) passes through a sheet thickness detection section 90 through some conveyance rollers, and is conveyed to a transfer position (a gap between the photoconductive drum 1 and the transfer unit 5A). At the transfer position, the transfer unit 5A transfers the toner image to the sheet from the photoconductive drum 1. The charge removing unit 5B erases the charge on the surface of the sheet on which the toner image is transferred. The separating pawl 5C separates the sheet from the photoconductive drum 1. Thereafter, the sheet is conveyed by an intermediate conveyance section 5D, is heated and pressed by the fixing unit 8, and the toner image is fixed to the sheet. The sheet subjected to the fixing is discharged from a discharge section 5E and is outputted to the sheet finishing apparatus 20.

The cleaning unit 6 disposed downstream of the separating pawl 5C removes a developer remaining on the surface of the photoconductive drum 1, and prepares for next image formation.

The sheet finishing apparatus 20 includes a sheet folding apparatus 30 and a sheet placement section 40 in addition to a sorter section to sort sheets.

The sheet folding apparatus 30 performs a process (saddle stitching) in which the center of plural printed sheets discharged from the image forming section 12 is stitched with staples, and then, folding is performed to form a booklet. There is also a case where only folding is performed without saddle stitching with staples, and the folded sheet bundle is stacked on the sheet placement section 40.

The booklet subjected to saddle stitching and folding (or folding alone) by the sheet folding apparatus 30 is outputted to the sheet placement section 40, and the booklet (sheet bundle) is finally mounted here.

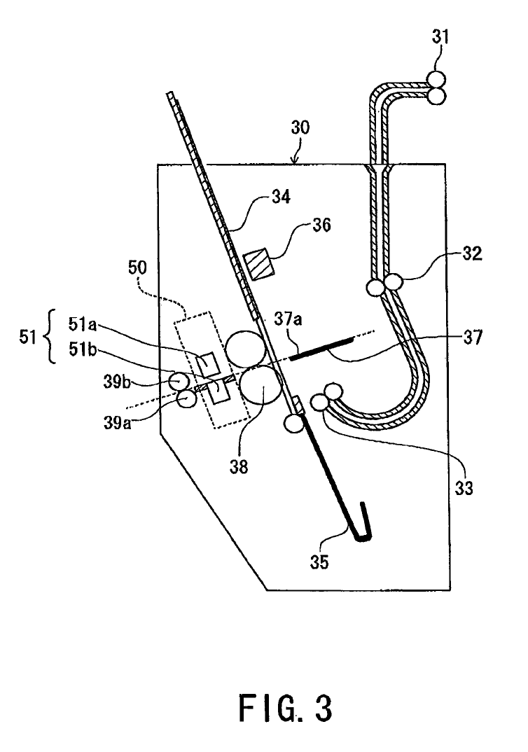

FIG. 3 is a sectional view showing a detailed structural example of the sheet folding apparatus 30.

The sheet folding apparatus 30 receives the sheet discharged from the discharge section 5E of the image forming section 12 by an inlet roller pair 31 and delivers it to an intermediate roller pair 32. The intermediate roller pair 32 further delivers the sheet to an exit roller pair 33. The exit roller pair 33 sends the sheet to a standing tray 34 having an inclined placement surface. The leading edge of the sheet is directed to the upper part of the inclination of the standing tray 34.

A stacker 35 is provided below the standing tray 34, and receives the lower edge of the sheet which is switched back and falls from the upper part of the inclination of the standing tray 34.

A stapler (saddle stitch unit) 36 is disposed at the middle of the standing tray 34. When saddle stitching (stapling) is performed on the sheet bundle, the position of the stacker 35 is adjusted so that the position of the sheet bundle to be stapled (the center of the sheet bundle in the up-and-down direction) faces the stapler 36.

After the stapler 36 saddle stitches the sheet bundle, then, the stacker 35 descends until the position of the sheet bundle where a fold line is to be formed (the center of the sheet bundle in the up-and-down direction and the position where the staples are inserted) comes to the front of a fold blade 37.

When the position where the fold line is to be formed comes to the front of the fold blade 37, a leading edge 37a of the fold blade 37 pushes a surface which becomes an inner surface after the sheet bundle is folded.

A fold roller pair 38 is provided ahead of the fold blade 37 in the traveling direction. The sheet bundle pushed by the fold blade 37 is rolled into a nip of the fold roller pair 38, and the fold line is formed at the center of the sheet bundle. The fold blade 37 and the fold roller pair 38 constitute a fold unit.

The sheet bundle on which the fold line is formed by the fold roller pair 38 is conveyed to a fold reinforcing unit 50 provided at the downstream side thereof. The sheet bundle conveyed to the fold reinforcing unit 50 is temporarily stopped there.

The fold reinforcing unit 50 includes a fold reinforcing roller 51 (a pair of rollers including an upper roller 51a and a lower roller 51b). The reinforcing roller pair 51 moves in the direction (direction along the line of the fold line) perpendicular to the conveyance direction of the sheet bundle while applying pressure to the fold line, and reinforces the fold line.

The sheet bundle whose fold line is reinforced by the fold reinforcing unit 50 again starts to be conveyed, is pulled by a discharge roller pair 39a, 39b and is outputted to the sheet placement section 40. The sheet bundle subjected to the saddle stitching, that is, the booklet is placed on the sheet placement section 40.

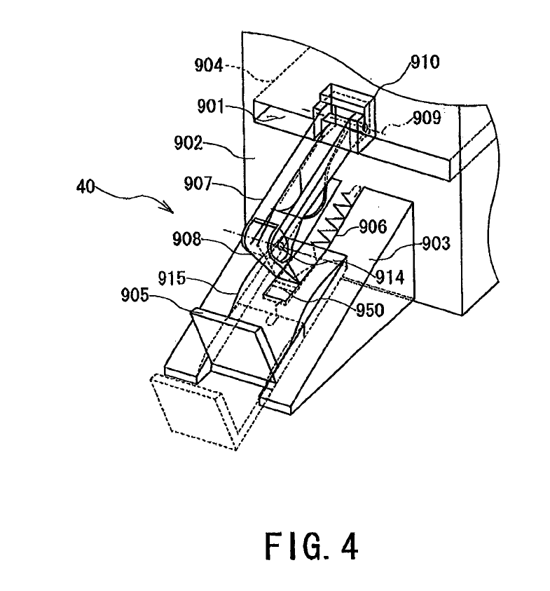

FIG. 4 is an enlarged view showing the sheet placement section 40 of the sheet finishing apparatus 20.

The sheet placement section 40 includes a bed 903, a base plate 915, an upper arm 907 and a fore arm 908. A detachable and attachable guard 905 is provided at a leading edge of the base plate 915.

The base plate 915 is connected to an outer side wall 902 of the main body of the sheet finishing apparatus 20 through a spring 906, and is, together with the bed 903, inclined downward and extends from the side wall 902 of the main body. Plural booklets successively discharged from an outlet 901 provided in the side wall 902 are stacked on the base plate 915.

Abase end of the upper arm 907 is rotatably supported around a shaft 909 provided in a support 910 fixed to the side wall 902.

A shaft 914 is provided at the front end of the upper arm 907, and the upper end of the fore arm 908 is rotatably supported by the shaft 914.

The base plate 915 has a gentle hill at the center in the direction along the inclination, and a flapper 950 is provided in the vicinity of the top of the hill. Besides, a hollow is formed in an upper portion of the inclination of the flapper 950. The lower end of the fore arm 908 is hooked in this hollow, and the fore arm 908 is substantially perpendicular to the stacking surface of the base plate 915.

A booklet stacked on the base plate 915 moves downward along the bed 903 and the stacking surface of the base plate 915 by its own weight, and the leading edge of the booklet is received by the fore arm 908.

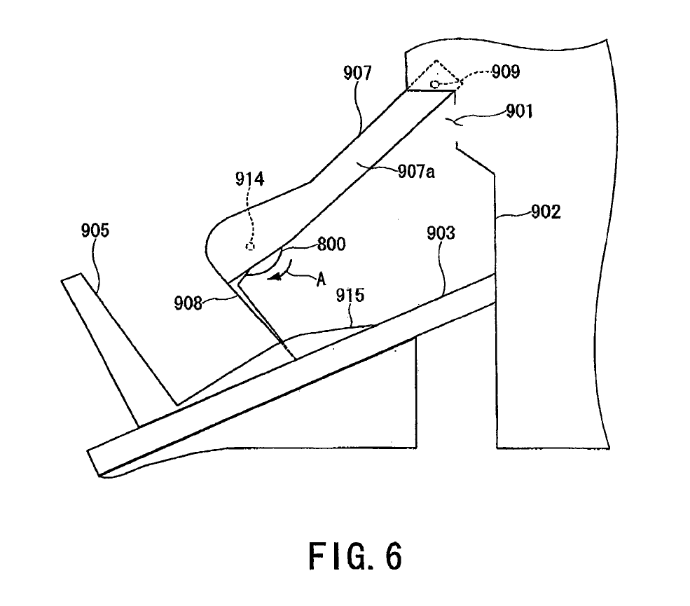

As described later, an alignment roller 800 is provided at the front end of the upper arm 907 (see FIG. 6 etc.), and this alignment roller 800 improves a longitudinal alignment performance to align the leading edges of the stacked booklets.

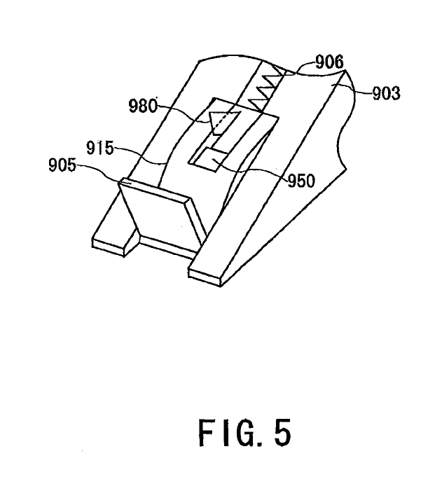

FIG. 5 is a view showing an appearance in which the upper arm 907 and the fore arm 908 are removed from the sheet placement section 40. A sheet sensor (not shown) to detect the booklet is contained in the inside of the bed 903, and the sheet sensor includes a detection lever 980. In a case in which a booklet is not placed on the base plate 915, as shown in FIG. 5, the detection lever 980 protrudes from the hollow of the base plate 915 and is exposed from the surface of the base plate 915. If merely one booklet is placed on the base plate 915, the detection lever 980 sinks by the weight of the booklet. By the movement of the detection lever 980, the sheet sensor can distinguish between a state (non-stacking state) where no booklet is stacked on the base plate 915 and a state (stacking state) where one or more booklets are stacked.

FIG. 6 is a schematic view in which the sheet placement section 40 is seen from the front direction (the direction viewed from the operation section 9 shown in FIG. 1). As described above, the sheet placement section 40 includes the bed 903, the base plate 915, the upper arm 907 and the fore arm 908. The bed 903 and the base plate 915 are inclined downward and extend from the side wall 902 of the main body of the sheet finishing apparatus, and stack plural booklets successively discharged from the outlet 901 provided in the side wall. The guard 905 is provided at the lower end of the base plate 915.

The upper arm 907 is provided above the base plate 915 and substantially in parallel to the stacking surface of the base plate 915, and the base end thereof is rotatably supported by the shaft 909 at the upper part of the outlet 901.

The fore arm 908 extends from the front end of the upper arm 907 to the stacking surface to be substantially perpendicular to the base plate 915, and can receive the leading edge of the booklet stacked on base plate 915.

The alignment roller 800 is provided coaxially with the shaft 914 at the front end of the upper arm 907. The alignment roller 800 presses the upper surface of the booklet stacked on the base plate 915, and rotates in an arrow A direction to urge the booklet to the fore arm 908. The upper arm 907 includes a cover 907a, and FIG. 6 shows a state where a lower part of the alignment roller 800 is exposed from the cover 907a.

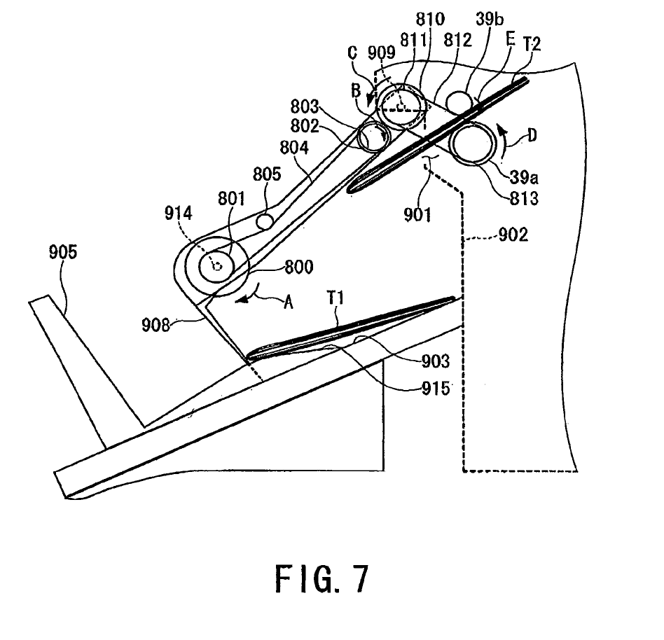

FIG. 7 is a view in which the cover 907a is removed, and is a view showing an example of a structure of a rotation force transmission mechanism to the alignment roller 800.

A pulley 801 is fixed to the alignment roller 800 coaxially with the shaft 914. A drive gear 810 and an intermediate gear 802 are provided in the vicinity of the base end of the upper arm 907, and the gears 810 and 802 are engaged with each other.

A pulley 803 is coaxially fixed to the intermediate gear 802. A belt 804 is stretched between the pulley 803 and the pulley 801 of the alignment roller 800 through a tension roller 805.

As shown in FIG. 7, the rotation shaft of the drive gear 810 is coaxial with the rotation shaft 909 of the upper arm 907. The rotation shaft of the drive gear 810 and the rotation shaft 909 of the upper arm 907 are not fixed, and can be rotated freely from each other.

The discharge roller pair 39a, 39b (see also FIG. 3) for discharging the booklet to the sheet placement section 40 exist on the inside of the side wall 902 of the main body of the sheet finishing apparatus, and a rotation shaft of a not-shown motor is coupled to the shaft of the discharge roller 39a. A pulley 813 and the pulley 811 are respectively coaxially fixed to the discharge roller 39a and the drive gear 810, and a belt 812 is stretched between the pulley 813 and the pulley 811.

The discharge roller 39a rotates in a direction of an arrow D by the rotation of the motor, and the discharge roller 39b (driven roller) rotates in an arrow E direction. By this rotation, the booklet formed in the main body of the sheet finishing apparatus 20 passes through the outlet 901 and is discharged to the sheet placement section 40. FIG. 7 shows a situation where a first booklet T1 has been already stacked on the base plate 915 and a second booklet T2 is being pushed out from the outlet 901.

Meanwhile, the rotation force of the motor is transmitted through the belt 812 to the drive gear 810, and the drive gear rotates in an arrow C direction. The rotation is transmitted to the intermediate gear 802, and the intermediate gear 802 rotates in an arrow B direction. The rotation of the intermediate gear 802 is further transmitted to the alignment roller 800 through the belt 804, and rotates the alignment roller 800 in the direction of the arrow A.

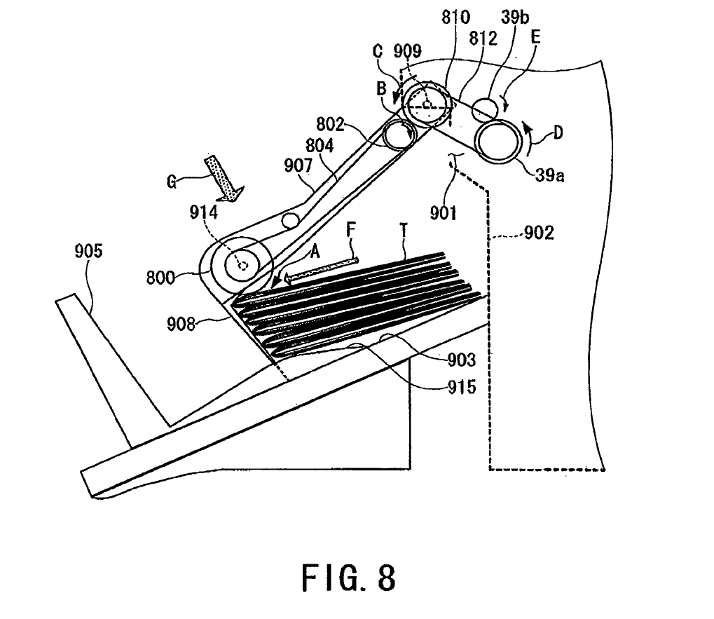

FIG. 8 is a view for explaining the operation and effect of the alignment roller 800 of the embodiment and the rotation force transmission mechanism to the alignment roller 800.

A booklet T discharged from the outlet 901 slides down on the bed 903 and the base plate 915 by its own weight, and the leading edge thereof is received by the fore arm 908 and is stopped.

The booklets successively discharged from the outlet 901 are stacked on the previously discharged booklet. When the number of booklets becomes large, depending on a type of a sheet of the booklet, there is a case where the center parts of the booklets are bent downward and a hollow is generated. There is a case where the booklet discharged later is stopped by this hollow before the leading edge of the booklet reaches the fore arm 908. Besides, the stop positions of the booklets discharged later can become irregular due to the friction between the booklets. That is, there can occur a case where the longitudinal alignment of the booklets becomes insufficient. There is a tendency that this phenomenon in which the longitudinal alignment is insufficient becomes remarkable as the number of booklets becomes large, that is, the height of the stacked booklet bundles approaches the upper arm 907.

In order to deal with the phenomenon as stated above, the alignment roller 800 which presses the upper surface of the booklet and rotates in the direction of urging the booklet to the fore arm 908 (the direction of an arrow F and the arrow A in FIG. 8) is provided in the vicinity of the front end of the upper arm 907 of the embodiment.

The upper surface of the booklet, especially the upper surface of the booklet positioned at the uppermost position when the number of booklets becomes large is urged in the direction toward the fore arm 908 by the rotation of the alignment roller 800. As a result, the leading edge of the booklet can be aligned at the position of the fore arm 908, and the longitudinal alignment can be improved.

Besides, in the rotation force transmission mechanism of the upper arm 907 of this embodiment, the intermediate gear 802 is provided between the drive gear 810 and the alignment roller 800. The rotation directions of the drive gear 810 and the intermediate gear 802 are respectively the arrow C direction and the arrow B direction in FIG. 8. Accordingly, the downward force in FIG. 8 is exerted at the engagement point of the drive gear 810 and the intermediate gear 802, and the counterclockwise force in FIG. 8 is generated with respect to the rotation shaft 909 of the upper arm 907. The counterclockwise force is exerted downward at the position of the alignment roller 800, that is, in the direction G of pressing the booklet bundle.

As a result, the alignment roller 800 can convey the booklet in the direction toward the fore arm 908 while pressing the booklet from above, and the longitudinal alignment of the booklet bundle can be further improved.

So far, it has been explained that the leading edge of the booklet is received by the fore arm 908. Instead, it may be possible to configure the sheet placement section 40 without the fore arm 908. In this case, the leading edge of the booklet is received by, for example, the guard 905 located in a forward direction of the base plate 915, and the alignment roller 800 urges the booklet in a forward direction of the base plate 915, while pressing the booklet from above.

### (2) Second Embodiment

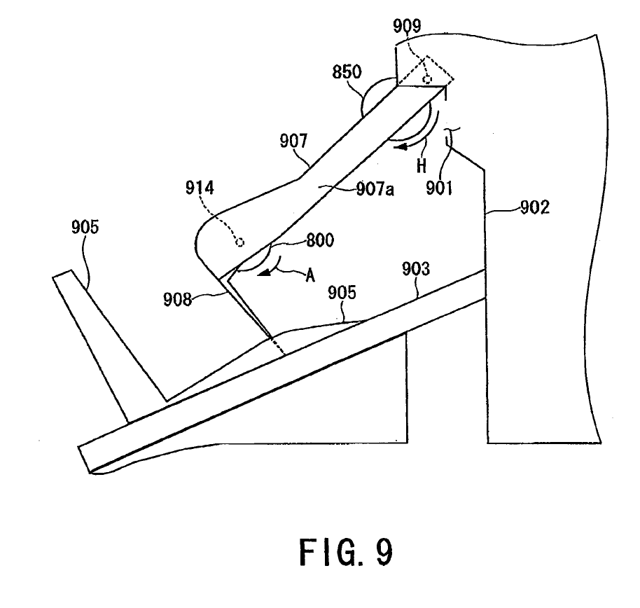

FIG. 9 is a schematic view in which a sheet placement section 40 of a second embodiment is seen from a front direction. A different point from the first embodiment is that a conveyance assist roller 850 is further provided in the vicinity of a base end of an upper arm 907. The rotation direction of the conveyance assist roller 850 is a direction of an arrow H, and is the same direction as the rotation direction of an alignment roller 800.

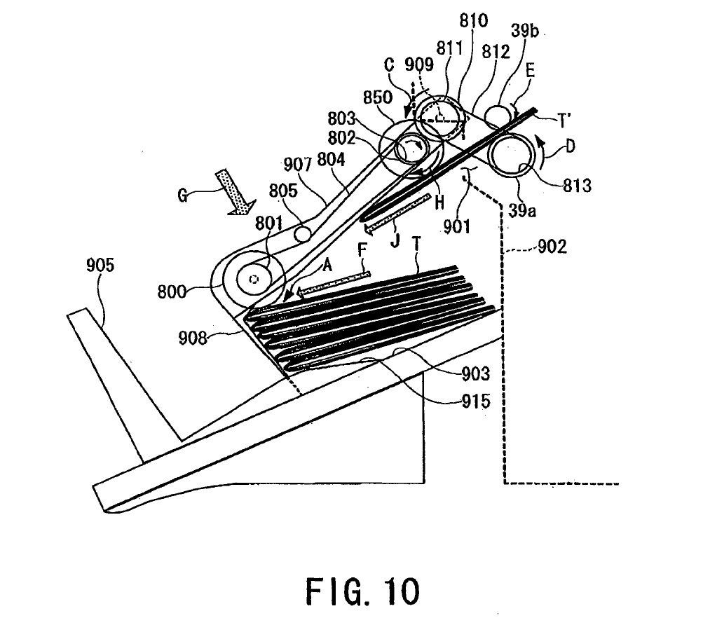

FIG. 10 is a view showing a drive mechanism of the conveyance assist roller 850 and the operation and effect of the conveyance assist roller 850.

The conveyance assist roller 850 is coaxially fixed to, for example, the shaft of the intermediate gear 802 in the first embodiment. As a result, the conveyance assist roller 850 can be rotated in the arrow H direction without adding a specific drive mechanism to the upper arm 907 of the first embodiment.

According to the first embodiment, the leading edge of the booklet bundle is pressed to the fore arm 908 by the rotation of the alignment roller 800 and the pressing from above, and the longitudinal alignment is improved. However, if the leading edge of the booklet does not reach the position of the alignment roller 800 due to the friction between the booklets, this effect of the alignment roller 800 is not obtained.

According to the second embodiment, the conveyance assist roller 850 is further provided to the upper arm 907, so that the booklet discharged from an outlet 901 is pushed to the alignment roller 800 positioned at the front end of the upper arm 907, and the booklet can be certainly sent to the position where the leading edge of the booklet contacts the alignment roller 800. In other words, the booklet is delivered from discharge rollers 39a and 39b, and can be further delivered to the alignment roller 800. As a result, the longitudinal alignment improving effect of the alignment roller 800 can be. made more certain.

As described above, according to the sheet finishing apparatus 20 including the sheet placement section 40 of the first or the second embodiment and the sheet finishing method, the leading edges of the booklets stacked on the sheet placement section 40 are uniformed and can be excellently aligned.

As a result, after the user takes out the booklet bundles from the sheet placement section 40, the operation of again aligning the booklet bundles at a different place is unnecessary, or, if any, the operation load of alignment is much reduced.

Besides, since the booklets stacked on the sheet placement section 40 are uniformly stacked, so-called “a collapse of a pile” does not occur, and paper jam of the booklet discharged later can be prevented.

Further, since the longitudinal alignment is improved, and the occurrence of the collapse of a pile is prevented, the number of booklets stacked on the sheet placement section 40 can be further increased.

While certain embodiments have been described, these embodiments have been presented by way of example only, and are not intended to limit the scope of the invention. Indeed, the novel apparatuses and units described herein may be embodied in a variety of other forms; furthermore, various omissions, substitutions and changes in the form of the apparatuses and units described herein may be made without departing from the spirit of the invention. The accompanying claims and their equivalents are intended to cover such forms or modifications as would fall within the scope and spirit of the invention.

What is claimed is:

1. A sheet finishing apparatus comprising:
a main body configured to fold a sheet bundle to form a booklet;
a base plate configured to be inclined downward and extend from a side wall of the main body and stack thereon a plurality of booklets successively discharged from an outlet provided in the side wall;
an upper arm configured to be provided above the base plate and substantially in parallel to a stacking surface of the base plate, a base end of the upper arm being rotatably supported at an upper position of the outlet of the side wall;
a fore arm configured to extend from a front end of the upper arm to the stacking surface to be substantially perpendicular to the base plate and receive a leading edge of the booklet stacked on the base plate; and
an alignment roller configured to be provided at the front end of the upper arm, press an upper surface of the booklet stacked on the base plate and rotate in a direction of urging the booklet to the fore arm.

2. The apparatus of claim 1, wherein the alignment roller presses the upper surface of the booklet stacked at the uppermost side among the plurality of booklets stacked on the base plate.

3. The apparatus of claim 1, wherein an upper end of the fore arm is rotatably supported at the front end of the upper arm and a lower end is hooked in a hollow formed in the stacking surface.

4. The apparatus of claim 1, further comprising:
a drive gear provided coaxially with a rotation shaft of the upper arm;
at least one intermediate gear engaging with the drive gear; and
a belt to transmit a rotation force of the intermediate gear to the alignment roller,
wherein a rotation direction of a rotation force acting around the rotation shaft of the upper arm is a direction in which the alignment roller presses the upper surface of the booklet stacked on the base plate.

5. The apparatus of claim 4, further comprising:
a discharge roller to discharge the booklet from the outlet; and
a motor to drive the discharge roller,
wherein the motor further drives the drive gear.

6. The apparatus of claim 1, further comprising:
a conveyance assist roller configured to be disposed near the base end of the upper arm, rotate and contact the upper surface of the booklet discharged from the outlet, and send the booklet to the alignment roller.

7. The apparatus of claim 6, further comprising:
a drive gear provided coaxially with a rotation shaft of the upper arm;
an intermediate gear engaging with the drive gear; and
a belt to transmit a rotation force of the intermediate gear to the alignment roller,
wherein the conveyance assist roller is coaxially fixed to a rotation shaft of the intermediate gear.

8. A sheet finishing method comprising:
folding a sheet bundle to form a booklet;
stacking a plurality of booklets, which are successively discharged from an outlet provided in a side wall, on a base plate inclined downward and extending from the side wall of a main body for forming the booklet;
rotatably supporting a base end of an upper arm, which is provided above the base plate and substantially in parallel to a stacking surface of the base plate, at an upper position of the outlet of the side wall;
receiving a leading edge of the booklet stacked on the base plate by a fore arm which extends from a front end of the upper arm to the stacking surface to be substantially perpendicular to the base plate; and
pressing an upper surface of the booklet stacked on the base plate by an alignment roller provided at the front end of the upper arm, and urging the booklet to the fore arm by rotation of the alignment roller.

9. The method of claim 8, wherein the alignment roller presses the upper surface of the booklet stacked at the uppermost side among the plurality of booklets stacked on the base plate.

10. The method of claim 8, wherein an upper end of the fore arm is rotatably supported at the front end of the upper arm and a lower end is hooked in a hollow formed in the stacking surface.

11. The method of claim 8, further comprising:
providing a drive gear coaxially with a rotation shaft of the upper arm;
engaging at least one intermediate gear with the drive gear; and
transmitting a rotation force of the intermediate gear to the alignment roller by a belt,
wherein a rotation direction of a rotation force acting around the rotation shaft of the upper arm is a direction in which the alignment roller presses the upper surface of the booklet stacked on the base plate.

12. The method of claim 11, further comprising:
discharging the booklet from the outlet by a discharge roller; and
driving the discharge roller by a motor,
wherein the motor further drives the drive gear.

13. The method of claim 8, further comprising
causing a conveyance assist roller, which is disposed near the base end of the upper arm, to rotate and to contact the upper surface of the booklet discharged from the outlet, and sending the booklet to the alignment roller.

14. The method of claim 13, further comprising:
providing a drive gear coaxially with a rotation shaft of the upper arm;
engaging an intermediate gear with the drive gear; and
transmitting a rotation force of the intermediate gear to the alignment roller by a belt,
wherein the conveyance assist roller is coaxially fixed to a rotation shaft of the intermediate gear.

15. A sheet finishing apparatus comprising:
a main body configured to fold a sheet bundle to form a booklet;
a base plate configured to be inclined downward and extend from a side wall of the main body and stack thereon a plurality of booklets successively discharged from an outlet provided in the side wall;
an upper arm configured to be provided above the base plate and substantially in parallel to a stacking surface of the base plate, a base end of the upper arm being rotatably supported at an upper position of the outlet of the side wall; and
an alignment roller configured to be provided at the front end of the upper arm, press an upper surface of the booklet stacked on the base plate and rotate in a direction of urging the booklet to the forward side of the base plate.

16. The apparatus of claim 15, wherein the alignment roller presses the upper surface of the booklet stacked at the uppermost side among the plurality of booklets stacked on the base plate.

17. The apparatus of claim 15, further comprising:
a drive gear provided coaxially with a rotation shaft of the upper arm;
at least one intermediate gear engaging with the drive gear; and
a belt to transmit a rotation force of the intermediate gear to the alignment roller,
wherein a rotation direction of a rotation force acting around the rotation shaft of the upper arm is a direction in which the alignment roller presses the upper surface of the booklet stacked on the base plate.

18. The apparatus of claim 17, further comprising:
a discharge roller to discharge the booklet from the outlet; and
a motor to drive the discharge roller,
wherein the motor further drives the drive gear.

19. The apparatus of claim 15, further comprising:
a conveyance assist roller configured to be disposed near the base end of the upper arm, rotate and contact the upper surface of the booklet discharged from the outlet, and send the booklet to the alignment roller;
a drive gear provided coaxially with a rotation shaft of the upper arm;
an intermediate gear engaging with the drive gear; and
a belt to transmit a rotation force of the intermediate gear to the alignment roller,
wherein the conveyance assist roller is coaxially fixed to a rotation shaft of the intermediate gear.

20. A sheet finishing method comprising:
folding a sheet bundle to form a booklet;
stacking a plurality of booklets, which are successively discharged from an outlet provided in a side wall, on a base plate inclined downward and extending from the side wall of a main body for forming the booklet;
rotatably supporting a base end of an upper arm, which is provided above the base plate and substantially in parallel to a stacking surface of the base plate, at an upper position of the outlet of the side wall; and
pressing an upper surface of the booklet stacked on the base plate by an alignment roller provided at the front end of the upper arm, and urging the booklet to the forward side of the base plate by rotation of the alignment roller.
